(19) United States
(12) Patent Application Publication
(10) Pub. No.: US 2024/0063643 A1
(43) Pub. Date: Feb. 22, 2024

(54) SWITCH BOX

(71) Applicant: DESIGNWERK TECHNOLOGIES AG, CH-8408 WINTERTHUR (CH)

(72) Inventor: Frank LOACKER, Pfungen (CH)

(73) Assignee: DESIGNWERK TECHNOLOGIES AG, CH-8408 WINTERTHUR (CH)

(21) Appl. No.: 18/270,079

(22) PCT Filed: Jan. 5, 2022
(86) PCT No.: PCT/EP2022/050123

§ 371 Date: Jun. 28, 2023

(30) Foreign Application Priority Data
Jan. 11, 2021 (CH) 00015/21

(51) Int. Cl. H02J 7/00

(52) U.S. Cl. CPC H02J 7/0024; H02J 7/0019; H02J 2310/48

(57) ABSTRACT

The disclosure relates to a charging system (1) for an electric vehicle comprising a first battery system (2) and a second battery system (3) interconnected to each other by a switch box (4) interconnected to a charging device (8) during charging Each battery system (2, 3) comprising at least one battery (21) and at least one thereto connected electrical load (22). The switch box (4) interconnects the first battery system (2) and the second battery system (3) with the charging device (8) in a parallel mode in a parallel manner or in a serial mode in a serial manner.

### BACKGROUND OF THE INVENTION

### Field of the Invention

The present disclosure is directed towards the field of charging systems for electric vehicles. More particularly it is directed towards charging systems with at least one battery and a switch box interconnecting the battery and an external power supply.

### Discussion of Related Art

Electric vehicles using more than one battery are known from the prior art. During charging, these batteries are connected to an external power source.

US 2012007557 A1 published in January 2012, in the name of AEROVIRONMENT INC. relates to a fast charge configuration for a power supply of electric vehicles. The charger configuration includes a serial connection to a pair of batteries each having an output that is half that required by the device, such as the electric vehicle, in which the batteries are to be used. When the batteries are connected to the vehicle, they are connected in parallel.

U.S. Ser. No. 10/727,680 B2 published in July 2020, in the name of NIO USA INC relates to a junction box for an electric vehicle. The junction box includes a charging port to receive power from an external power source, and a plurality of switching elements to control electrical connections between the charging port, a first battery, and a second battery. On/off states of the plurality of switching elements control whether the charging port, the first battery and the second battery are connected in a first configuration or a second configuration.

### SUMMARY OF THE INVENTION

Charging systems for electric vehicles as known from the prior art have several disadvantages facing a heterogeneous charging station infrastructure and the desire for fast and optimized charging. The charging should be done as fast as the individual charging station allows, without overheating the components of the charging system. Furthermore, the charging system should be constructed in a simple, compact and robust manner, in order to be able to handle the high voltages and currents during charging.

A first aspect of the disclosure is directed to a charging system for an electric vehicle typically comprising a first battery system and a second battery system during charging interconnected to each other by a switch box. Said switch box usually comprises a housing and a positive inlet pole and a negative inlet pole during charging operation interconnected to a charging device. The switch box comprises generally a first positive outlet pole and a first negative outlet pole interconnected to the first battery system and a second positive outlet pole, and a second negative outlet pole interconnected to the second battery system.

A battery system can be understood as a system comprising at least one electrical energy storage. Depending on the design the at least one electrical energy storage may be formed as a battery cell and/or a battery module comprising at least one battery cell and/or a battery pack comprising at least one battery module. The first and second battery system may be formed as single battery pack comprising at least a first and at least a second battery module; however, the first and the second battery system can each comprise at least one battery pack.

To allow optimal charging for various different charging stations, respectively charging devices, the switch box is preferably configured to interconnect the first battery system and the second battery system in a parallel mode and in a serial mode to the charging device. The parallel mode and the serial mode are typically not configured simultaneously. In the parallel mode the positive inlet pole can be interconnected to the first positive outlet pole and via an engaged first switch to the second positive outlet pole, while the negative inlet pole is interconnected to the second negative outlet pole and via an engaged second switch to the first negative outlet pole. This way the first and the second battery systems are interconnected to the positive and the negative inlet pole in a parallel manner. In the serial mode the first and the second switches are disengaged, and the first negative outlet pole can be interconnected via an engaged third switch to the second positive outlet pole in a serial manner. In the serial mode the positive inlet pole is still interconnected to the first positive outlet pole and the negative inlet pole is still interconnected to the second negative outlet pole. This way the first and the second battery systems are interconnected to the positive and the negative inlet pole in a serial manner.

Preferably the first battery system and the second battery system are essentially symmetrical. In particular, the first battery system and the second battery system are operated on essentially the same voltage. The first battery system and/or the second battery system can comprise at least one battery and at least one thereto connected electrical load. For good performance, each battery system preferably comprises at least one battery and at least one thereto connected electrical load respectively.

The charging system can be configured to obtain information of the voltage, that can be supplied by the individual charging station. In case the individual charging station, respectively charging device, can provide twice the operating voltage of the first battery system and/or the second battery system, the switch box can be configured to switch to the serial mode, such that optimal charging can be achieved. Accordingly, if the individual charging station, respectively charging device, can provide only the operating voltage of the first battery system and/or the second battery system the switch box can be configured to switch to the parallel mode, to achieve the fastest charging possible.

Good results are possible when the loads of the first battery system and the loads of the second battery system are controllable during charging, such that the loads of the first battery system and the loads of the second battery system consume essentially equal electrical power. This allows to charge the batteries of the first battery system and the second battery system in a balanced manner. In order to achieve this the first and/or the second battery system preferably comprise a balancing load. The balancing load can be formed by a controllable resistance, such as a heater or the like. In some variations a single balancing resistance is switchably interconnected to the first and the second battery system. In this case the balancing load can be connected to the battery system having a lower consumption of electrical power during charging compared to the other battery system, such that the balancing load can balance the consumption of both battery systems to essentially correspond. Furthermore, since the loads are arranged within the respective battery system there is no need for a DCDC converter to halve the voltage during charging in the serial mode, as the operating voltage is already applied independently of the charging mode (parallel or serial).

The switch box is preferably formed as a separate part, and is in particular arranged on board the electric vehicle. An advantage herein is the easy retrofittability for electric vehicles having a pair of battery systems, as the switch box can be interposed between the battery systems and the charging device, respectively inlet, by a simple rewiring.

Depending on the design, the housing of the switch box is essentially box-shaped; however, other shapes are possible. The housing of the switch box is preferably closed, and in particular sealed, to provide protection against weather, in particular water. The housing can be made at least partially from metal or other robust materials. Depending on the field of application, at least one cooling fin can be attached to the outside of the housing and in thermal contact therewith in order to increase the (passive) cooling performance of the switch box. The switches are preferably thermally interconnected to the housing or another heat sink. If appropriate, the housing may comprise a thermal member with at least one cooling channel connected to a cooling circuit, for cooling the components arranged inside the housing.

The switches are preferably incorporated as relays. The switch box may comprise a control unit interconnected to the switches to operate the relays. If appropriate the control unit is arranged inside the housing; however, the control unit may be incorporated into the vehicle control unit or the battery systems management unit. The switches can be connected to the control unit directly via cable or indirectly via a CAN-Bus (Controller Area Network) connection. The control unit may be configured to monitor an operating parameter of at least one of the components of the switch box, in particular the temperature of the thereto connected switches.

Preferably the connections between the inlet poles and the outlet poles are made at least partially from conductive sheet metal, in particular can the connections be formed as busbars. Depending on the field of application the connections between the inlet/outlet poles and the switches interposed between them can be at least partially made from electrically conductive sheet metal. The use of sheet metal has the advantage that it has a larger surface area for a given cross-section area compared to a round cable, allowing an improved heat dissipation.

A compact construction is possible, when inside the housing, the positive outlet poles are arranged on a first level and the negative outlet poles are arranged on a second level, wherein the first level and the second level are vertically spaced apart from each other. If appropriate at least one of the conductive sheet metals can be bent and extends at least partially over two levels. The electrical contact of the sheet metals with the respective switches is preferably made in the same level, in particular in the first level. The height of the switches in the vertical direction is preferably essentially corresponds to twice the distance between the first level and the second level in the vertical direction

For a robust and safe construction, insulators, in particular busbar insulators, are spacing apart the first level and the second level. In a preferred variation, the insulators are spacing apart the conductive sheet metals arranged in the first level and the second level at least partially on top of each other in the vertical direction. Insulators may also be arranged between the housing and the second level to space apart the second level from an inside of the housing. The insulators preferably comprise fastening means, such as inside threads or screw connectors, so that the insulators may be fastened to the housing and the second level, or between the first level and the second level. This way the connections between the poles, formed by conductive sheet metals, are securely fastened inside the housing.

In order to reduce the cable lengths required for interconnecting the switch box to the first and the second battery system, the first outlet poles and the second outlet poles are preferably arranged on two non-adjacent sides of the housing, in particular on two opposing sides of the housing. The batteries of the first battery system can typically be arranged on a first side of the electric vehicle, while the batteries of the second battery system can be arranged on a second side of the electric vehicle. When the switch box is arranged between the first and the second side of the electric vehicle, a minimal cable length is needed when the respective outlet poles are on two opposing sides of the housing, each facing the respective battery system.

An easy wiring during installation of the switch box is possible, when each outlet pole is interconnected to the respective battery system by two essentially parallel cables. This way the required cross-section area of the cables/conductors for the high currents is provided, while the cables are still flexible enough to be easily installed. A further advantage is the increased surface area of two cables, each having half the cross-section area of a single cable with the same cross-section area, as heat dissipation is improved by the larger surface area. It should be understood that more than two cables are thinkable as well.

The inlet and outlet poles are preferably incorporated as circular connectors, in particular quick latch connectors, for connecting cables to the inlet and outlet poles in a plug and socket manner. However, other possible connector types are known.

The charging system may comprise at least one high voltage distribution unit (HVDU) per battery system. Each battery system may in particular comprise two high voltage distribution units, one for connecting the batteries of a battery system and one for connecting the electrical loads of a battery system. In a preferred variation the switch box is connected to one HVDU per battery system, which is then interconnected to the other HVDU.

A second aspect of the disclosure is directed to a method for operating a charging system for an electric vehicle. The charging system may be one of the variations described above, but typically comprises a first battery system and a second battery system interconnected to each other by a switch box interconnected to a charging device during charging. Each battery system usually comprises at least one battery and at least one thereto connected electrical load. Generally, the switch box interconnects the first battery system and the second battery system with the charging device in a parallel mode in a parallel manner or in a serial mode in a serial manner.

The method typically comprises switching between the parallel mode and the serial mode depending on characteristics of the charging device. The characteristics of the charging device may comprise, but are not limited to, the charging voltage and/or the time period in which a certain charging voltage can be provided by the charging device. The charging system can be configured to obtain the characteristics of the charging device and to configure the switch box in parallel or serial mode accordingly. In particular, the switch box comprises a control unit switching between the serial mode and the parallel mode.

Preferably are the loads of the first battery system and the second battery system controlled during charging, such that the loads of the first battery system and the loads of the second battery system consume essentially equal electrical power. This allows to charge the batteries of the first battery system and the second battery system in a balanced manner and an imbalanced state of charge between the batteries of the first and the second battery system can be avoided.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings which should not be considered limiting to the disclosure described in the appended claims. The drawings are showing:

FIG. 1 shows a first variation of a switch box (opened) according to the disclosure;

FIG. 2 shows the first variation of the switch box of FIG. 1 in a partially exploded view;

FIG. 3 shows the first variation of the switch box of FIG. 2 in an exploded view (without the housing);

FIG. 4 shows schematic layout of a first variation of a charging system according to the disclosure; and

FIG. 5 shows a schematic circuit diagram of a switch box according to the disclosure.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

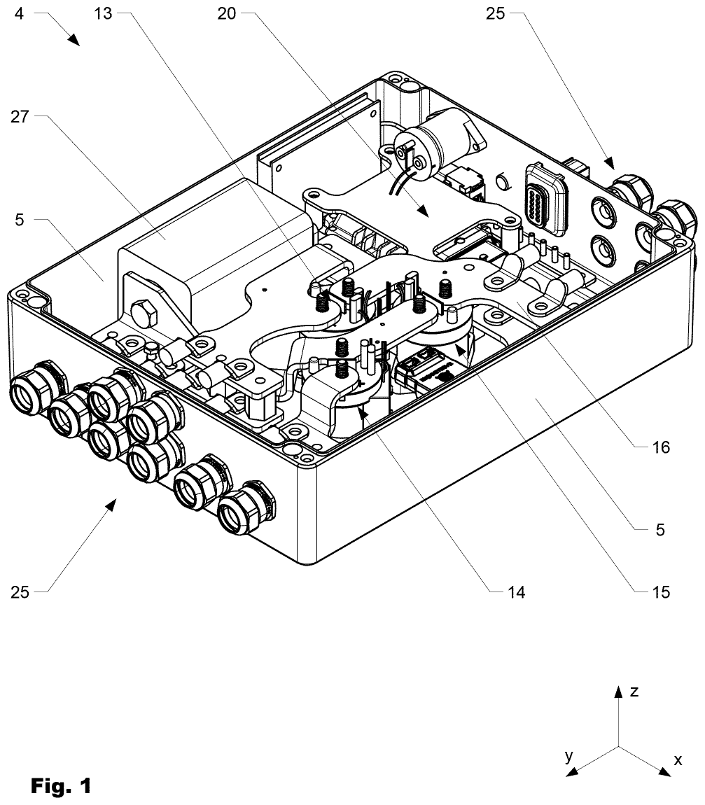

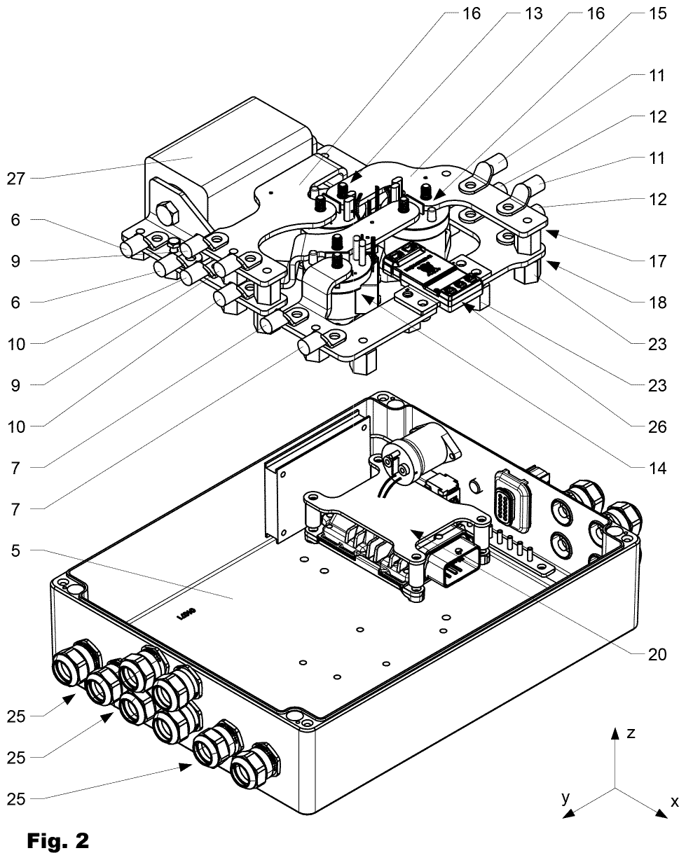

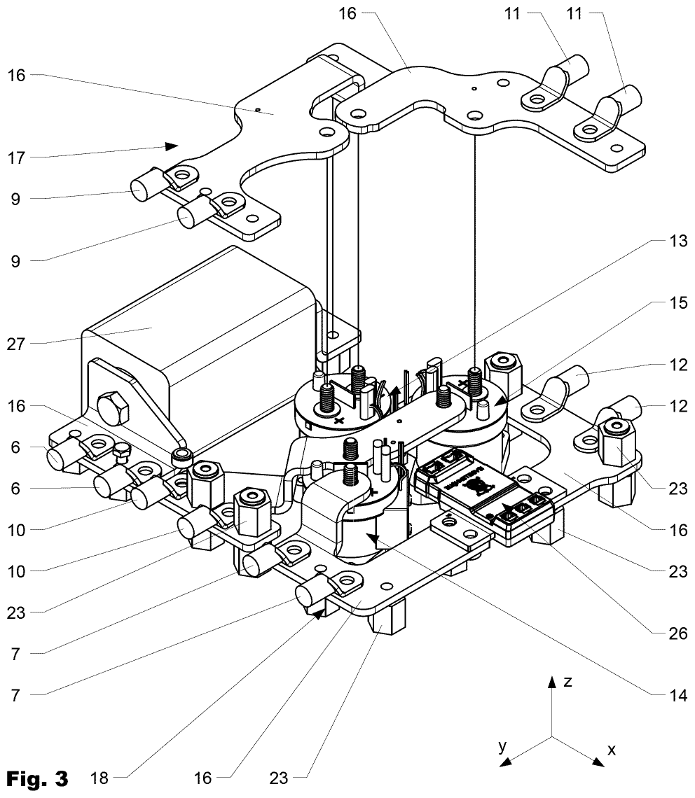

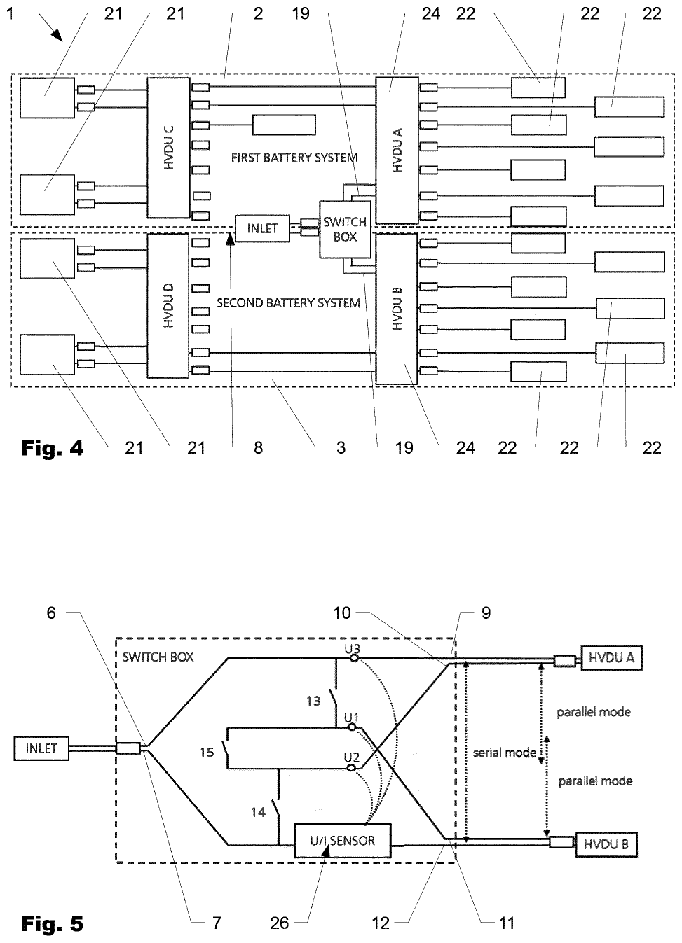

FIG. 1 shows a first variation of a switch box 4 (opened) according to the disclosure and FIGS. 2 and 3 show the first variation in exploded views. FIG. 4 illustrates a schematic layout of a first variation of a charging system 1 according to the disclosure. FIG. 5 shows a schematic circuit diagram of a switch box 4 according to the disclosure.

As visible in FIG. 4 the charging system 1 typically comprises a first battery system 2 and a second battery system 3 interconnected to each other by a switch box 4. The switch box 4 is interconnected to a charging device 8 (not explicitly shown) during charging via an inlet. The battery systems 2, 3 usually comprise at least one battery 21, in the variation shown they each comprise two batteries 21. The batteries 21 are preferably of a similar kind, in particular having an essentially similar operating voltage. In addition, each battery system 2, 3 comprises at least one electrical load 22. It can be seen in FIG. 4 that the battery systems 2, 3 of the first variation each comprise a multiplicity of electrical loads 22 connected to a common high voltage distribution unit (HVDU) 24 (indicated with A and B). The batteries 21 of each battery system 2, 3 are connected to another HVDU 24 (indicated with C and D) respectively. The switch box 4 is interconnected to the first and second battery systems 2, 3 and the charging device 8 (via the inlet) by means of cables 19. In the first variation the cable connections are formed by two essentially parallel cables 19.

The switch box 4 usually comprises a housing 5, as best visible in FIG. 1, and a positive inlet pole 6 and a negative inlet pole 7 during charging operation interconnected to a charging device 8. The switch box 4 comprises in addition, as shown in FIG. 2, a first positive outlet pole 9 and a first negative outlet pole 10 interconnected to the first battery system 2, in particular to a HVDU 24 (A) of the first battery system 2. Furthermore, the switch box 4 comprises a second positive outlet pole 11 and a second negative outlet pole 12 interconnected to the second battery system 3, in particular to a HVDU 24 (B) of the second battery system 3.

The switch box 4 is preferably configured interconnect the first battery system 2 and the second battery system 3 in a parallel mode or in a serial mode to the charging device 8, respectively via the inlet. In FIG. 5 the circuit for connecting the two battery systems 2, 3 in serial and parallel is schematically shown. In order to achieve this the switch box 4 comprises a first switch 13 and a second switch 14, which are engaged in the parallel mode and disengaged in the serial mode. A third switch 15 is engaged in the serial mode, while it is disengaged in the parallel mode.

From FIG. 4 it can be seen, that the first battery system 2 and the second battery system 3 are essentially symmetrical. This symmetry can be found in terms of the layout of their respective components, but also in terms of their operating voltage. In the shown first variation, the operating voltage of the first battery system 2 and the second battery system 3 is about 400 volts, however other voltages are thinkable as well.

In FIG. 5, U1 to U3 indicate voltage measurements during charging, performable by a voltage and current sensor 26 interposed between the negative inlet pole 7 and the second negative outlet pole 12. In the parallel mode, U1 is essentially equal to U3, in the shown first variation U3 is around 400 volts. In the serial mode U1 is essentially equal to U2, in the shown variation around 400 volts, however U3 is essentially equal to twice of U1 or U2, here U3 is around 800 volts. Charging in the serial mode is particularly made possible as the electrical loads 22 of both battery systems 2, 3 are controlled to consume essentially equal amounts of electrical power. This way the batteries 21 of each battery system 2, 3 are charged in a balanced manner.

As shown in FIG. 1, the housing 5 of the switch box 4 of the first variation can be essentially box-shaped. The housing 5 is preferably made from a thermally conductive material, such as metal, to allow (passive) cooling of the thereto connected components. The switches 13, 14, 15 are incorporated as relays and engage and disengage in an electromechanical manner. The switches 13, 14, 15 are respectively attached to the housing 5, thereby they are thermally interconnected to the housing 5 for passive cooling via the housing 5.

The switch box can comprise a control unit 20, as shown in FIGS. 1 and 2, for controlling the engagement and disengagement of the switches 13, 14, 15. The control unit 20 is typically interconnected to a vehicle control unit (not shown). The control unit 20 may be configured to monitor the status of the components of the switch box 4, in particular the temperature of the switches 13, 14, 15.

As best visible in FIG. 3, the connections between the poles 6 to 12 are at least partially made from conductive sheet metal 16, in particular as busbars 16. To achieve a compact construction, the connections are arranged on a first level 17 and second level 18 spaced apart in a vertical direction z. Arranged between the first level 17 and the second level 18 are typically insulators 23, for spacing apart the levels 17, 18 in the vertical direction. Insulators are preferably also arranged between the housing 5 and the second level 18 for spacing apart the second level 18 from the housing 5 and for attaching the connections in the second level 18 to the housing 5 via the insulators 23.

FIG. 3 further shows that in the first variation the conductive sheet metal 16 connections are interconnected to the switches 13, 14, 15 on the first level 17. The switches 13, 14, 15 each have a vertical extension from the housing 5, where they are attached to, through the second level 18 to the first level 17. If appropriate the conductive sheet metals 16 are bent and extend at least partially over two levels.

The first variation of the switch box 4, as shown in FIG. 1, comprises preferably cable glands 25 for connecting the charging device 8 via the inlet to the inlet poles 6, 7. The cable glands 25 are typically attached to the housing 5 for securely passing cables (not shown) through a side wall of the housing 5. Further cable glands 25 for connecting the first battery system 2 via the first poles 9, 10 and for connecting the second battery system 3 via the second poles 11, 12 are arranged on opposing sides on the housing 5. In the shown variation each of the poles 6 to 12 is arranged next to two cable glands 25. This allows to interconnect to the respective battery system 2, 3 by two essentially parallel cables (not shown).

Rather, the words used in the specification are words of description rather than limitation, and it is understood that various changes may be made without departing from the scope of the disclosure

1. A charging system (1) for an electric vehicle comprising
a. a first battery system (2) and a second battery system (3) during charging interconnected to each other by a switch box (4);
b. the switch box (4) comprising a housing (5) and a positive inlet pole (6) and a negative inlet pole (7) during charging operation interconnected to a charging device (8) and a first positive outlet pole (9) and a first negative outlet pole (10) interconnected to the first battery system (2) and a second positive outlet pole (11) and a second negative outlet pole (12) interconnected to the second battery system (3), wherein
i. in a parallel mode the positive inlet pole (6) is interconnected to the first positive outlet pole (9) and via an engaged first switch (13) to the second positive outlet pole (11), while the negative inlet pole (7) is interconnected to the second negative outlet pole (12) and via an engaged second switch (14) to the first negative outlet pole (10) in a parallel manner;
ii. in a serial mode the first and the second switches (13, 14) are disengaged and the first negative outlet pole (10) is interconnected via an engaged third switch (15) to the second positive outlet pole (11) in a serial manner.

2. The charging system according to claim 1, wherein the switches (13, 14, 15) are incorporated as relays (13, 14, 15).

3. The charging system according to claim 1, wherein the switch box (4) comprises a control unit (20) interconnected to the switches (13, 14, 15) to operate the relays (13, 14, 15).

4. The charging system according to claim 1, wherein the switches (13, 14, 15) are thermally interconnected to the housing (5).

5. The charging system according to claim 1, wherein connections between the inlet poles (6,7) and the outlet poles (9, 10, 11, 12) are at least partially made from conductive sheet metal (16).

6. The charging system according to claim 1, wherein inside the housing (5) the positive outlet poles (9, 11) are arranged on a first level (17) and the negative outlet poles (10, 12) are arranged on a second level (18), wherein the first level (17) and the second level (18) are vertically spaced apart from each other.

7. The charging system according to claim 5, wherein at least one of the conductive sheet metals (16) is bent and extends at least partially over two levels (17, 18).

8. The charging system according to claim 6, wherein insulators (23) space apart the first level (17) and the second level (18) conductive sheet metals (16) at least partially on top of each other.

9. The charging system according to claim 1, wherein the first outlet poles (9, 10) and the second outlet poles (11, 12) are arranged on two opposing non-adjacent sides of the housing (5).

10. The charging system according to claim 1, wherein each outlet pole (9, 10, 11, 12) is interconnected to a respective battery system (2, 3) by two essentially parallel cables (19).

11. The charging system according to claim 1, wherein the first battery system (2) and/or the second battery system (3) comprise at least one battery (21) and at least one thereto connected electrical load (22).

12. The charging system according to claim 11, wherein the first battery system (2) and the second battery system (3) are essentially symmetrical.

13. The charging system according to claim 11, wherein the loads (22) of the first battery system (2) and the loads (22) of the second battery system (3) are controllable during charging, such that the loads (22) of the first battery system (2) and the loads (22) of the second battery system (3) consume essentially equal electrical power, in order to charge the batteries (21, 21) of the first battery system (2) and the second battery system (3) in a balanced manner.

14. An electrical vehicle comprising a charging system (1) according to claim 1.

15. A method for operating a charging system (1) for an electric vehicle,
a. the charging system comprising:
i. a first battery system (2) and a second battery system (3) interconnected to each other by a switch box (4) interconnected to a charging device (8) during charging, each battery system (2, 3) comprising at least one battery (21) and at least one thereto connected electrical load (22),
ii. the switch box (4) interconnecting the first battery system (2) and the second battery system (3) with the charging device (8) in a parallel mode in a parallel manner or in a serial mode in a serial manner;
b. the method comprising the following steps:
i. switching between the parallel mode and the serial mode depending on characteristics of the charging device (8).

16. The method according to claim 15, wherein the loads (22) of the first battery system (2) and the second battery system (3) are controlled during charging, such that the loads (22) of the first battery system (2) and the loads (22) of the second battery system (3) consume essentially equal electrical power to charge the batteries (21, 21) of the first battery system (2) and the second battery system (3) in a balanced manner.
